(19) United States
(12) Patent Application Publication
(10) Pub. No.: US 2025/0217207 A1
(43) Pub. Date: Jul. 3, 2025

(54) Translation Barrier Instruction

(71) Applicant: Apple Inc., Cupertino, CA (US)

(72) Inventor: Jeff Gonion, Campbell, CA (US)

(21) Appl. No.: 18/970,633

(22) Filed: Dec. 5, 2024

Related U.S. Application Data
(60) Provisional application No. 63/616,008, filed on Dec. 29, 2023.

(51) Int. Cl. G06F 9/52; G06F 9/30; G06F 9/38; G06F 12/1027

(52) U.S. Cl. CPC G06F 9/522; G06F 9/30101; G06F 9/3836; G06F 12/1027

(57) ABSTRACT

An apparatus may include a processor circuit that may be configured to execute a translation barrier instruction. To execute the translation barrier instruction, the processor circuit may be configured to prevent, until after the translation barrier instruction completes, address translations for instructions that occur subsequent to the translation barrier instruction in program order. The processor circuit may be further configured to complete the translation barrier instruction based on finishing all address translations for instructions that occur prior to the translation barrier instruction in program order.

### PRIORITY CLAIM

The present application claims priority to U.S. Provisional App. No. 63/616,008, entitled “Translation Barrier Instruction,” filed Dec. 29, 2023, the disclosure of which is incorporated by reference herein in its entirety.

### BACKGROUND

### Technical Field

Embodiments described herein are related to computer systems, including systems-on-a-chip (SOCs) and multi-die packages. More particularly, the disclosed embodiments are directed towards methods for synchronizing address translations in an out-of-order processor.

### Description of the Related Art

Computer systems, such as systems-on-chip (SOCs), generally include one or more processors that serve as central processing units (CPUs) for a system, along with various other components such as memory controllers and peripheral components. Some processors perform instructions in order, in which a first instruction is completed before a next instruction is allowed to complete. Certain long-lead operations, such as memory fetches, may take multiple clock cycles to complete, causing an in-order processor to stall while instructions subsequent to the memory fetch wait for the memory fetch to complete. These processor stalls may have a negative impact on processor performance. To mitigate processor stalls, some processors are configured to allow out-of-order processing in which instructions subsequent to a long-lead instruction may be allowed to be executed if they are not dependent on a result of the long-lead instruction. Out-of-order processing allows a processor to avoid idling while waiting for a long-lead instruction to complete, thereby increasing efficiency.

In addition to out-of-order processing, some processors may use virtual-to-physical address mapping in order to, for example, support relocation of program code into available memory space. Applications, for example, may be written using virtual address references in order to support a wide variety of computing devices. For a given device, such applications may be stored in a first available portion of a nonvolatile memory space and then copied into and executed from a different portion of a volatile memory space. When the program code is stored or copied, a virtual-to-physical address mapping may be performed. When the program code is executed, virtual addresses referenced in the code are translated into the physical addresses corresponding to the portion of address space in which the program code and associated information are currently stored.

### BRIEF DESCRIPTION OF THE DRAWINGS

The following detailed description makes reference to the accompanying drawings, which are now briefly described.

FIG. 1 illustrates a block diagram of an embodiment of a processor circuit that supports a translation barrier instruction.

FIG. 2 shows a block diagram of an embodiment of a processor circuit that may be implemented in the system of FIG. 1.

FIG. 3 depicts a flow diagram of an embodiment of a method for performing a translation barrier instruction.

FIG. 4 illustrates a flow diagram of an embodiment of another method for performing a translation barrier instruction.

FIG. 5 shows a flow diagram of an embodiment of a method for stalling instructions in response to execution of a translation barrier instruction.

FIG. 6 depicts a flow diagram of an embodiment of a method for performing a speculative translation request in combination with execution of a translation barrier instruction.

FIG. 7 illustrates various embodiments of systems that include coupled integrated circuits.

FIG. 8 shows a block diagram of an example computer-readable medium, according to some embodiments.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims.

### DETAILED DESCRIPTION OF EMBODIMENTS

Use of out-of-order processing may present several issues during operation of a computer system. For example, due to out-of-order processing, two or more program threads may become disjointed from program order with one thread getting multiple instructions ahead of another. At a certain point, the thread that is running ahead may become dependent on an event occurring in the lagging thread. Such events may include address-translation, the determination of memory permissions, and modification of system registers. Regarding address translations, a launch of a different application may result in a new address translation table being generated. Moreover, a currently active application may branch to processes that had not been previously loaded into the volatile execution memory, thereby resulting in different program code being loaded and causing additions to an existing address translation table. Instructions being executed out of order may, therefore, need to be synchronized with changes to address translation tables in order to avoid, e.g., an older instruction improperly using an address translation that is not valid until after the execution of the older instruction.

To synchronize operations in a processor to a common point in the program order, out-of-order processors may utilize barrier instructions. A barrier instruction may be used to stall program threads that are running ahead of slower program threads, allowing the slower threads to “catch up” such that all associated program threads are at a common point in the program order. Mechanisms that may be employed by barrier instructions include, for example, the prevention of speculative operations, flushing instruction pipelines and re-fetching instructions, and the like.

Use of such barrier-instruction mechanisms may, however, negatively impact performance. Speculative operations are commonly used to prefetch instructions and data to reduce wait times associated with memory accesses. Flushing an execution pipeline that has instructions that have been fetched, decoded, and are ready to issue results in all the processing used to fetch and decode these instructions being wasted. New fetch and decode operations are then performed to refill the flushed pipeline.

Accordingly, a new barrier instruction is contemplated that applies to address translation while avoiding flushing pipelines and allowing some speculative operations to proceed. Such a barrier instruction may also apply to changes to system registers pertaining to a translation lookaside buffer (TLB). Such a barrier instruction may prevent the barrier from completing until all translations occurring in program order prior to the barrier have completed. Until the contemplated barrier instruction completes, no translations that occur after the barrier in program order may be performed. In some embodiments, such a barrier instruction may also apply to changes to registers which affect address translation or permissions in a TLB. For example, the barrier instruction may not complete until all changes to these translation registers that occur in program order prior to the barrier have completed. In addition, changes to these registers occurring in program order after the barrier may be prevented until the barrier instruction completes. Examples of such translation registers include registers which hold the base-address of tables (such as page-tables or permission tables), or registers which control other aspects of translation and/or permissions. In other embodiments, the barrier instruction may apply to all system registers, rather than simply those which control address translations or permissions.

As used herein, to “complete” an instruction refers to the instruction progressing through an instruction pipeline to a point in which the instruction is ready to be retired. In various embodiments, it is contemplated that completion may refer to a point in which the instruction is retired or to a point in which the instruction is waiting for older instructions to complete in order to be retired.

The disclosed embodiments address systems and methods for implementing a translation barrier instruction. For example, a proposed embodiment includes a processor circuit configured to execute a translation barrier instruction. The processor circuit may prevent, until after the translation barrier instruction completes, address translations for instructions that occur subsequent to the translation barrier instruction in program order. The processor circuit may also complete the translation barrier instruction based on finishing all address translations for instructions that occur prior to the translation barrier instruction in program order.

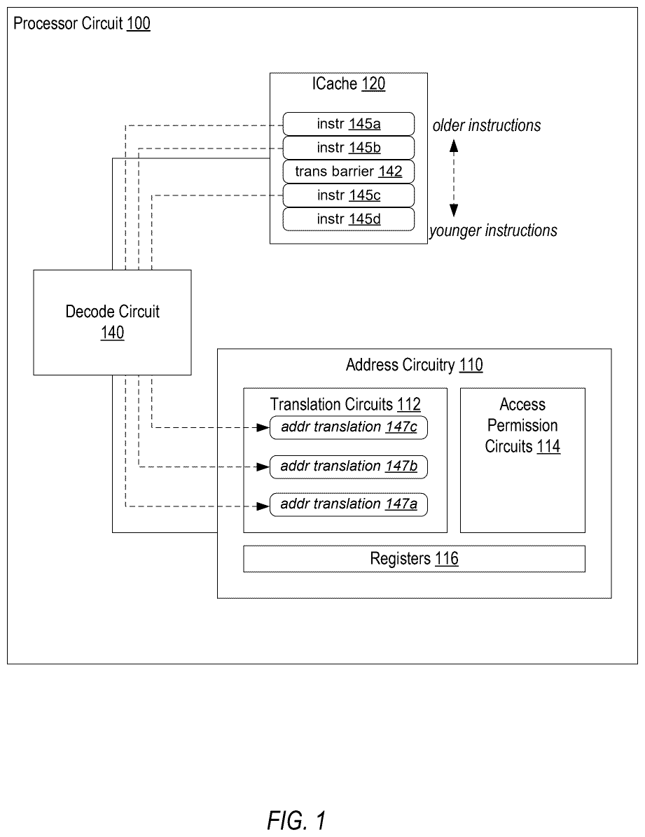

FIG. 1 illustrates a block diagram of an embodiment of a processor circuit, such as may be included on a system-on-chip (SOC). As illustrated, processor circuit 100 includes decode circuit 140 coupled to instruction cache (ICache) 120 and address circuitry 110. Instruction cache 120 is shown with instructions (instr) 145a-145d as well as translation barrier instruction 142. Address circuitry 110 includes translation circuits 112, access permission circuits 114, and registers 116. Processor circuit 100 may be, in whole or in part, included in a computing system, such as a desktop or laptop computer, a smartphone, a tablet computer, a wearable smart device, or the like. In some embodiments, processor circuit 100 is included in a single IC, such as a system-on-chip, or in a multi-die chiplet system.

As illustrated, processor circuit 100 may include one or more execution pipelines for processing instructions stored in instruction cache 120. In other embodiments, processor circuit 100 may include two or more cores included in a same processor complex. Processor circuit 100 may be configured to implement any suitable instruction set architecture (ISA), such as, e.g., ARM™, PowerPC®, Blackfin®, or ×86 ISAs, or combination thereof. As shown, processor circuit 100 is further configured to implement at least one additional instruction, including a translation barrier instruction (e.g., translation barrier instruction 142). Processor circuit 100 may fetch program instructions from one or more coupled memory circuits, and store the fetched instructions in instruction cache 120, including instructions 145 and translation barrier instruction 142. Older instructions, in terms of program order, are depicted at the top and younger instructions at the bottom of the five illustrated instructions. Actual locations within instruction cache 120, however, may be based on cache lines that correspond to a fetch address used to retrieve the instructions.

Decode circuit 140, as shown, is configured to receive and decode instructions from instruction cache 120. As part of an instruction decoding operation, decode circuit 140 may also be configured to identify operands included in a received instruction, such as instructions 145. In some instances, operands may be pointers or addresses that indicate a memory location where the operand data is stored. In such instances, decode circuit 140 may be configured to determine a virtual address for the operand data and to use address circuitry 110 to determine a physical address that corresponds to the virtual address.

As illustrated, address circuitry 110 is configured to receive translation requests for a particular virtual address. Address circuitry 110 may include circuits that are associated with converting a virtual address into a physical address. For example, translation circuits 112 may include one or more address translation tables and one or more translation lookup buffers. Access permission circuits 114 may include various circuits used to determine whether a current process thread has permission to access a particular address or range of addresses. Registers 116 may include registers associated with translation tables, such as a base address register as well as registers associated with defining particular address ranges and their associated access permissions. In various embodiments, the circuits of address circuitry 110 may be included in a single circuit block or may be distributed throughout processor circuit 100, such as within a plurality of memory management units. Transaction requests may, in some embodiments, be associated with data reads and writes generated in response to the execution of code in processor circuit 100. Transaction requests may be included in an instruction fetch or prefetch operation. Program code may use virtual addresses rather than explicit physical addresses for accessing memory locations in a computer system. Such virtual addressing may allow the program code to be executed by a variety of hardware systems that may have different physical memory maps. The virtual addressing may also allow the program code to be executed with a variety of other programs without accessing similar addresses as the other programs.

Decode circuit 140 retrieves instructions from instruction cache 120 and identifies a type of the instruction and initiates decoding of any included operands, includes source and/or destination addresses for data consumed and/or generated by the instructions. As illustrated, decode circuit 140 retrieves instructions 145a-145c, and initiates translations for respective addresses associated with these instructions. Address circuitry 110 has, as depicted, initiated addresses translations 147a-147c, associated with instructions 145a-145c, respectively.

As illustrated, processor circuit 100 is configured to execute translation barrier instruction 142. For example, decode circuit 140 retrieves translation barrier instruction 142 from instruction cache 120, and then decodes and issues the barrier instruction. Processor circuit 100 is configured to, based on the issuing of translation barrier instruction 142, prevent, until after translation barrier instruction 142 completes, address translations for instructions that occur subsequent to the translation barrier instruction 142 in program order. In the present example, decode circuit 140 may retrieve and decode instruction 145d after translation barrier instruction 142 has issued but has not completed. Based on the issue of translation barrier instruction 142, an address translation, if required for instruction 145d, is not performed while execution of translation barrier instruction 142 is active. If, however, instruction 145d does not require an address translation, then instruction 145d may be issued and executed.

As shown, processor circuit 100 may also be configured to complete translation barrier instruction 142 based on finishing all address translations for instructions that occur prior to translation barrier instruction 142 in program order. Address translations 147a and 147b, associated with instructions 145a and 145b, may be allowed to continue since these instructions come prior to translation barrier instruction 142 in program order. In some embodiments, decode circuit 140 may actively monitor such outstanding translation operations, e.g., by polling a status associated with the in-flight translation operations. In other embodiments, decode circuit 140 may receive an indication from address circuitry 110 for each in-flight address translation 147a and 147b when a respective translation result is available.

Based at least in part on a determination that outstanding address translations 147a and 147b are complete, processor circuit 100 may be further configured to retire translation barrier instruction 142. Address translations for processor circuit 100 are now synchronized with translation barrier instruction 142, and address translations for younger instructions, such as instructions 145c and 145d, may proceed.

As illustrated, address translation 147c may be in-flight when translation barrier instruction 142 is issued. As instruction 145c is younger than translation barrier instruction 142, instruction 145c is not permitted to proceed. In some embodiments, address translation 147c may be stalled in address circuitry 110, or may be allowed to continue but a result of the translation may be prevented from being used and/or cached. In other embodiments, address translation 147c may be cancelled, and a new address translation request for instruction 145c issued from decode circuit 140 after translation barrier instruction 142 completes.

In some embodiments, processor circuit 100 may further include a set of one or more system registers that are associated with TLB 105. This set of system registers may include a base-address of a table (e.g., a page-table or a permission table), or registers which control other aspects of address translation and/or permissions for accessing secure addresses. Ones of the set of registers may be included in address circuitry 110 and/or located in other circuits within processor circuit 100. In addition to preventing address translations for instructions younger than translation barrier instruction 142, processor circuit 100 may also prevent, until after translation barrier instruction 142 completes, changes to the set of system registers that occur subsequent to translation barrier instruction 142 in program order. For example, instruction 140d may modify a value in one of the set of system registers. Processor circuit 100 may prevent in one or more of a variety of ways, instruction 140d from modifying the associated system register. In some embodiments, decode circuit 140 may not issue instruction 140d while execution of translation barrier instruction 142 is active. In other embodiments, instruction 140d may be allowed to be issued and executed, but the new value may be buffered until translation barrier instruction 142 completes. After translation barrier instruction 142 completes, the buffered value may be moved into the associated system register.

Processor circuit 100 may be further configured to, complete translation barrier instruction 142 based on finishing all changes to the set of system registers that occur prior to translation barrier instruction 142 in program order. For example, instruction 145b may be an instruction that includes a store of a new base address to a register in a translation table. If instruction 145b has not completed when translation barrier instruction 142 is issued, then processor circuit 100 allows the store of the new base address to be performed prior to completing translation barrier instruction 142.

In general, processor circuit 100 does not stall performance of instructions, but rather prevents younger address translations from proceeding. In some cases, however, processor circuit 100 may be further configured to stall one or more instructions in order to provide sufficient time for the older address translations to complete. For example, decode circuit may stall issuing instructions younger than translation barrier instruction 142 in cases in which the younger instructions are dependent on a blocked address translation that is prevented from proceeding until translation barrier instruction 142 completes.

In some embodiments, processor circuit 100 may be configured to, prior to issue of translation barrier instruction 142, issue a speculative translation request for an instruction that occurs subsequent, in program order, to translation barrier instruction 142. For example, processor circuit 100 may issue, to address circuitry 110, a speculative address translation request associated with instruction 145d that comes after translation barrier instruction 142 in program order. Instruction 145d may, e.g., be a conditional branch instruction for which a branch prediction circuit in processor circuit 100 predicts a taken branch, thereby triggering a prefetch operation to a virtual address indicated by instruction 145d. A speculative translation request may be generated to determine a physical address mapped to the virtual address to be used in the prefetch operation. Subsequent to the issuing (but prior to completion) of translation barrier instruction 142, processor circuit 100 may be configured to prevent a result of the speculative translation request from being cached in an associated TLB. Since instruction 145d falls after, in program order, translation barrier instruction 142, processor circuit 100 may be configured to block the translation result for the speculative branch address from being stored and, therefore, available for use for the prefetch operation.

As disclosed above, processor circuit 100 may further include a set of one or more system registers related to operation of processor circuit 100. Such registers may include system configuration registers that, for example, impact system permissions and/or security permissions for some or all processing circuits in an IC that includes processor circuit 100. In some embodiments, the set of system registers may include all system registers. In other embodiments, the set of system registers may include all registers that affect address translation. In another embodiment, the set of system registers may include all registers that affect address permissions. In some embodiments, the set of system registers may include all registers that affect address translation and/or address permissions. One such system register may include a base address register that stores a base address of a page table or a permission table.

It is noted, that in various embodiments, processor circuit 100 may be configured to determine if outstanding translation operations and changes to the set of system registers, all occurring prior to translation barrier instruction 142, are completed prior to retiring translation barrier instruction 142. Furthermore, processor circuit 100 may, under some conditions, stall translation operations and system register changes that occur subsequent to translation barrier instruction 142. In addition, processor circuit 100 may prevent caching of speculative translations that were initiated before the issuing of, but are younger than, translation barrier instruction 142.

Translation barrier instruction 142 may be used, for example, to synchronize translation operations to a point in a program where translation barrier instruction 142 is placed. A synchronization of the translation operations may be performed prior to modifying an address translation table. Accordingly, based at least in part on a determination that the outstanding translation operations are complete, processor circuit 100 may be further configured to determine that conditions for translation barrier instruction 142 have been fulfilled. After this determination that the conditions have been fulfilled, processor circuit 100 may perform one or more operations that modify a translation table. For example, instructions 145c and/or 145d may change a base address and/or translation permissions in the address translation table which, in turn, may change how virtual addresses are mapped to physical addresses in subsequent translation operations. This synchronization may prevent a lagging older address translation operation from improperly accessing the address translation table after it is modified by instructions occurring after the lagging address translation in program order. Similarly, younger address translations that are running ahead of the modification of address translation table, but that occur later in program order, may be prevented from improperly accessing pre-modified information in the address translation table.

It is noted that processor circuit 100, as illustrated in FIG. 1, is merely an example. The illustration of FIG. 1 has been simplified to highlight features relevant to this disclosure. Various embodiments may include different configurations of the circuit elements. For example, three elements of processor circuit 100 are shown. In other embodiments, other circuit elements may be included, such as one or more address translation tables and translation lookaside buffers, one or more execution units, a load/store unit, a data cache, a branch prediction circuit, and the like. Furthermore, instruction cache 120 in the illustrated processor circuit is shown with five instructions. In other embodiments, the instruction cache may include any suitable number of instructions. In various embodiments, processor circuit 100 may be implemented using any suitable combination of sequential and combinatorial logic circuits. In addition, register and/or memory circuits, such as SRAM, may be used in these circuits to temporarily hold information such as instructions, data, address values, and the like.

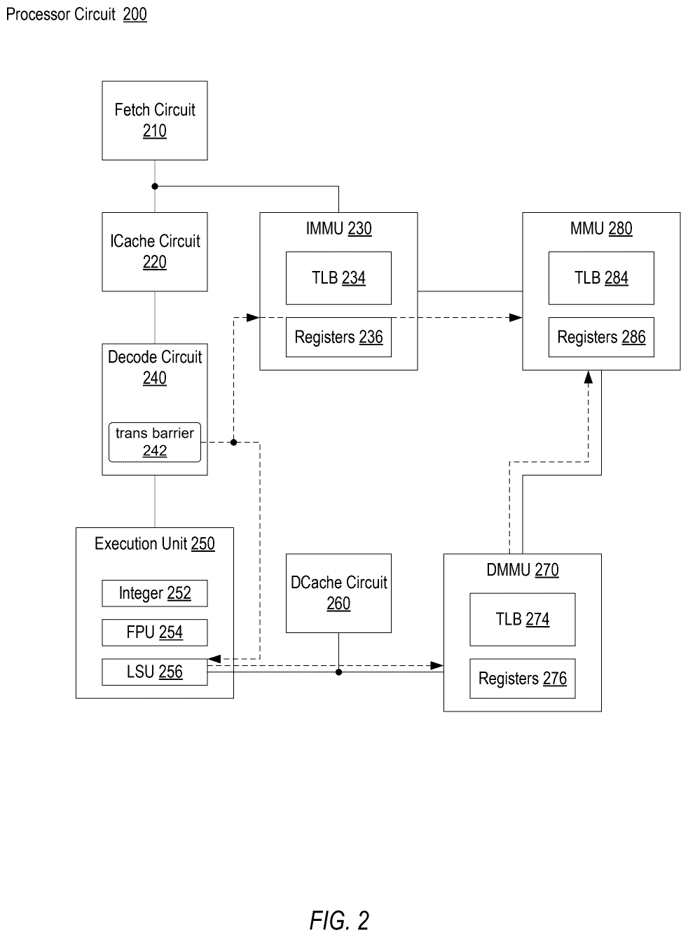

FIG. 1 depicts use of a translation barrier instruction that allows address translation operations to be synchronized in a processor circuit. Processor circuits may be implemented in a variety of manners. FIG. 2 illustrates another example of a processor circuit.

Moving to FIG. 2, a block diagram an embodiment of a processor circuit that implements a translation barrier instruction is illustrated. In some embodiments, processor circuit 200 may correspond to processor circuit 100 in FIG. 1. Processor circuit 200 includes fetch circuit 210, instruction cache (ICache) circuit 220, instruction memory management unit (IMMU) 230, decode circuit 240, execution unit 250, data cache (DCache) circuit 260, data memory management unit (DMMU) 270, and memory management unit (MMU) 280. IMMU 230 includes translation lookaside buffer (TLB) 234 and registers 236. Execution unit 250 includes a plurality of execution circuits, including integer unit 252, floating-point unit 254, and load-store unit 256. DMMU 270 includes translation lookaside buffer (TLB) 274 and registers 276. Similarly, MMU 280 includes translation lookaside buffer (TLB) 284 and registers 286. In some embodiments, fetch circuit 210, ICache circuit 220, decode circuit 240, execution unit 250, and DCache circuit 260 may be referred to as an instruction pipeline circuit of processor circuit 200.

Fetch circuit 210, as shown, may be configured to issue fetch requests to retrieve a group of one or more instructions based on a current program counter value and a presence of any flow control instructions (e.g., branch instructions, call instructions, return instructions, and the like). These fetch requests are sent to ICache circuit 220 and IMMU 230. If the fetch group has already been cached in ICache circuit 220, then IMMU 230 may do nothing in response to the fetch request. Otherwise, IMMU 230 may issue one or more memory transactions to retrieve instructions for the requested fetch group. These memory transactions may utilize address translations to convert a virtual address used by fetch circuit 210 into a physical address that is usable by IMMU 230 to generate the one or more memory transactions. IMMU 230 is configured to use TLB 234 to cache recently completed address translations.

As illustrated, memory transactions issued by IMMU 230 may be sent to MMU 280 for fulfillment. In some cases, TLB 234 may not include an entry corresponding to a requested fetch address. In such cases, the virtual address may be used in the memory transaction sent to MMU 280. After receiving the memory transaction without an address translation, MMU 280 may be configured to access TLB 284 to determine if an entry corresponding to the virtual address included in the received memory transaction exists. If so, then this entry may be used to determine a physical address for the memory transaction. Otherwise, MMU 280 may access a translation table to determine the physical address. A result of the translation table access may be stored in TLB 284 for subsequent use. After the physical address has been determined, MMU 280 may forward the memory transaction to one or more memory circuits (e.g., higher level caches, system memory circuits, nonvolatile storage circuits, and the like) to fulfill the memory transaction.

Decode circuit 240, as shown, is configured to receive and decode instructions from ICache circuit 220. As part of an instruction decoding operation, decode circuit 240 may also be configured to identify operands included in a received instruction. In some instances, operands may be pointers or addresses that indicate a memory location where the operand data is stored. In such instances, decode circuit 240 may be configured to determine a virtual address for the operand data and issue a memory request to DCache circuit 260 to determine if the operand data at the virtual address has been cached. If the virtual address is a miss in DCache circuit 260, then DMMU 270 may issue one or more memory transactions to MMU 280. In a similar manner as IMMU 230, DMMU 270 may access TLB 274 to determine if a virtual address of the desired operand data has a corresponding entry with the physical address translation. If so, then the physical address may be used in the memory transactions sent to MMU 280. If the virtual address misses in TLB 274, then MMU 280 may access TLB 284 to look for the physical address translation. As described above, another miss may result in the translation table being accessed to receive the virtual to physical mapping of the operand data address.

As illustrated, processor circuit 200 may configure TLBs 234, 274, and 284 for a first address space. For example, the first address space may correspond to particular application code assigned to processor circuit 200 for execution. Execution of the particular application code may include allocating a particular amount of system memory used to store instructions and data associated with the particular application code. The particular application code may be stored in a nonvolatile storage memory (e.g., flash memory or a hard drive disk) prior to being launched. After the first address space is allocated for the particular application, the stored code and related data (or portions thereof) may then be copied into the first address space based on virtual-to-physical address translations that are included in a translation table. As execution of the particular application progresses, the translation table is referenced to perform translation of virtual addresses used in the particular application code to physical addresses of the first address space to which the virtual addresses have been mapped. Such translations may then be cached into one or more of TLBs 234, 274, and 284 to reduce a time for performing subsequent translations of these previously translated virtual addresses.

Processor circuit 200, e.g., using decode circuit 240, may be configured to execute translation barrier instruction 242. For example, TLBs 234, 274, and 284 may be smaller than the translation table. As execution of the particular application progresses into a different portion of the code, resulting in translations of virtual addresses that were not previously translated. If an entry in one of TLBs 234, 274, and 284 is not available to cache a recent translation result, then an older entry may be selected, and the currently stored translation is evicted and replaced with the newer translation. To update the selected TLBs entries, processor circuit 200 receives and performs translation barrier instruction 242 prior to any changes being made to the selected TLBs entries.

Based at least in part on the execution of translation barrier instruction 242, processor circuit 200 may block translation operations that are pending in processor circuit 200 and that occur subsequent, in program order, to translation barrier instruction 242. Processor circuit 200 may also be configured to determine progress of outstanding translation operations in processor circuit 200 that occur prior, in program order, to translation barrier instruction 242. Instructions that are not dependent on a translation operation, however, may proceed, including issued instructions that are younger than translation barrier instruction 242.

Based at least in part in a determination that translations for the outstanding translation operations have been received, processor circuit 200 may proceed with execution of one or more instructions capable of modifying the configuration of TLBs 234, 274, and 284 for a second address space that is different from the first address space. For example, one or more TLB entries may be evicted and replaced with more recent translation results.

As shown, registers 236, 276, and 286 are associated with the configuration of TLBs 234, 274, and 284, respectively. Processor circuit 200 may be further configured to, based at least in part on the execution of translation barrier instruction 242, block changes to one or more of registers 236, 276, and 286 that occur subsequent, in program order, to translation barrier instruction 242. Furthermore, processor circuit 200 may be configured to determine whether pending changes to one or more of registers 236, 276, and 286 that occur prior, in program order, to translation barrier instruction 242 are complete. Based at least in part on a determination that the pending changes to the one or more of registers 236, 276, and 286 are complete, processor circuit 200 may proceed with the execution of the one or more instructions that are capable of modifying the configuration of TLBs 234, 274, and 284.

Processor circuit 200, as illustrated, may be further configured to, prior to executing translation barrier instruction 242, issue a speculative translation request for an instruction that occurs subsequent, in program order, to translation barrier instruction 242. Subsequent to executing translation barrier instruction 242, processor circuit 200 may be configured to prevent a result of the speculative translation request from being cached in any of TLBs 234, 274, and 284. After translation barrier instruction 242 completes, the result of the speculative translation request may be cached if the translation remains valid, e.g., a translation for the virtual address did not change between the beginning and end of execution of translation barrier instruction 242. If, however, the address space that includes the virtual address was updated during, or just after, the execution of translation barrier instruction 242, then processor circuit 200 may discard the result of the speculative translation request and reissue the request.

Processor circuit 200 may also include one or more system registers related to operation of processor circuit 200, for example, registers associated with execution unit 250, fetch circuit 210, decode circuit 240, and the like. In a similar manner as described above for registers 236, 276, and 286, processor circuit 200 may be further configured to, based at least in part on the execution of translation barrier instruction 242, stall changes to the one or more system registers that occur subsequent, in program order, to translation barrier instruction 242, and to determine whether pending changes to the one or more system registers that occur prior, in program order, to translation barrier instruction 242 are complete. Based at least in part on a determination that the pending changes are complete, processor circuit 200 may be further configured to proceed with the execution of the one or more instructions that are capable of modifying the configuration of TLBs 234, 274, and 284.

In some embodiments, processor circuit 200 may be further configured to, based at least in part in the determination that the execution of one or more instructions capable of modifying the configuration of TLBs 234, 274, and 284 has occurred, allow the blocked translation operations in processor circuit 200 to proceed. In addition, the result of the speculative translation request may be cached if the translation remains valid, e.g., a translation for the virtual address did not change between the beginning and end of execution of translation barrier instruction 242. If, however, the address space that includes the virtual address was updated during the execution of the one or more instructions, then processor circuit 200 may discard the result of the speculative translation request and reissue the request.

It is noted that the embodiment of FIG. 2 is one example of how a processor circuit that supports a translation barrier instruction may be implemented. Similar to FIG. 1, elements included in FIG. 2 are limited for clarity. In other embodiments, the processor circuit may also include additional elements such as branch prediction circuits, co-processors, and the like. In various embodiments, circuits of processor circuit 200 may be implemented using any suitable combination of sequential and combinatorial logic circuits. In addition, register and/or memory circuits, such as SRAM, may be used in these circuits to temporarily hold information such as instructions, data, address values, and the like.

To summarize, various embodiments of an apparatus may include a processor circuit that may be configured to execute a translation barrier instruction. To execute the translation barrier instruction, the processor circuit may be configured to prevent, until after the translation barrier instruction completes, address translations for instructions that occur subsequent to the translation barrier instruction in program order. The processor circuit may be further configured to complete the translation barrier instruction based on finishing all address translations for instructions that occur prior to the translation barrier instruction in program order.

In a further example, the apparatus may further comprise a set of system registers. To execute the translation barrier instruction, the processor circuit may be further configured to prevent, until after the translation barrier instruction completes, changes to the set of system registers that occur subsequent to the translation barrier instruction in program order, and to complete the translation barrier instruction based on finishing all changes to the set of system registers that occur prior to the translation barrier instruction in program order.

In some examples, the set of system registers may include all system registers. In other examples, the set of system registers may include all registers that affect address translation. In further examples, the set of system registers may include all registers that affect address permissions. In another example, the set of system registers may include all registers that affect address translation or address permissions. In a further embodiment, the set of system registers includes a base address register that stores a base address of a page table or a permission table.

In an example, the apparatus may further comprise one or more translation lookaside buffers (TLBs) that are configured to store virtual-to-physical address mappings. To execute the translation barrier instruction, the processor circuit may be configured to prevent, until after the translation barrier instruction completes, caching of address translations in the one or more TLBs for speculatively-executed instructions that occur subsequent to the translation barrier instruction in program order. In another example, to prevent the address translations for instructions that occur subsequent to the translation barrier instruction, the processor circuit may be configured to stall issuance of one or more instructions that occur subsequent to the translation barrier instruction in program order.

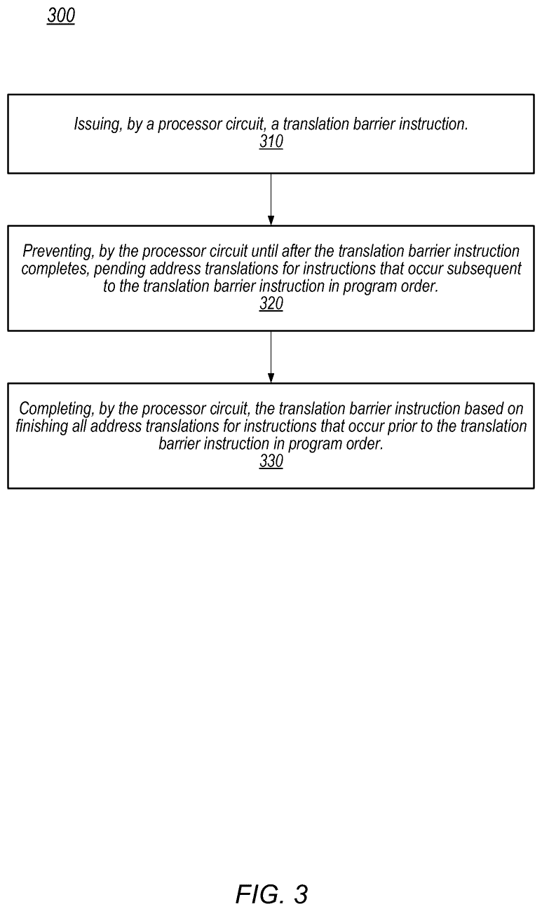

The circuits and techniques described above in regards to FIGS. 1 and 2 may perform a particular instruction using a variety of methods. Several methods associated with performing a translation barrier instruction are described below in combination with FIGS. 3-6. In some embodiments, the operations of the disclosed methods may be performed using instructions included in a non-transient, computer-readable memory having program instructions being executable by processor circuits in the systems to cause the operations described with reference to FIGS. 3-6.

Turning to FIG. 3, a flow diagram for an embodiment of a method for performing, by a processor circuit, a translation barrier instruction is shown. Method 300 may be performed by a processor circuit, such as processor circuits 100 and 200 in FIGS. 1 and 2, respectively. In some embodiments, the operations of method 300, or a portion thereof, may be performed by execution circuits in the system that perform instructions stored in a non-transient memory, for example, microcode hardcoded in the system. Method 300 is described below using processor circuit 100 of FIG. 1 as an example. References to elements in FIG. 1 are included as non-limiting examples.

Method 300 begins at block 310 with processor circuit 100 issuing translation barrier instruction 142. Translation barrier instruction 142, for example, may be issued after a translation table associated with address circuitry 110 has been populated with entries defining an address space associated with at least a portion of an active application.

In preparation for a change to the address space (e.g., a change to a different address space, or a change to access permissions for the address space), processor circuit 100 may issue translation barrier instruction 142 prior to modifying the translation table.

At block 320, method 300 continues with processor circuit 100 preventing, until after the translation barrier instruction completes, pending address translations for instructions that occur subsequent to translation barrier instruction 142 in program order. As described above, translation barrier instruction 142 may cause processor circuit 100 to stall translation operations until translation barrier instruction 142 is complete. In some embodiments, address circuitry 110 may stall in-flight address translation operations for, and/or decode circuit 140 may not issue address translation requests for, instructions younger than translation barrier instruction 142.

Method 300 may proceed, at block 330, with processor circuit 100, completing translation barrier instruction 142 based on finishing all address translations for instructions that occur prior to translation barrier instruction 142 in program order. In some embodiments, translation barrier instruction 142 does not complete until all older translation operations have completed. Accordingly, processor circuit 100 may retire translation barrier instruction 142 after all conditions associated with translation barrier instruction 142 have completed.

It is noted that the method of FIG. 3 includes blocks 310-330. Method 300 may end in block 330 or may repeat some or all blocks of the method. For example, method 300 may repeat block 320 for instructions added to instruction cache 120 while translation barrier instruction 142 remains active. Method 300 may be performed concurrently with a different instance of the method. For example, a system that includes processor circuit 100 may include other processor circuits, each processor circuit may independently execute a respective instance of a translation barrier instruction at different points in time, but that overlap processing.

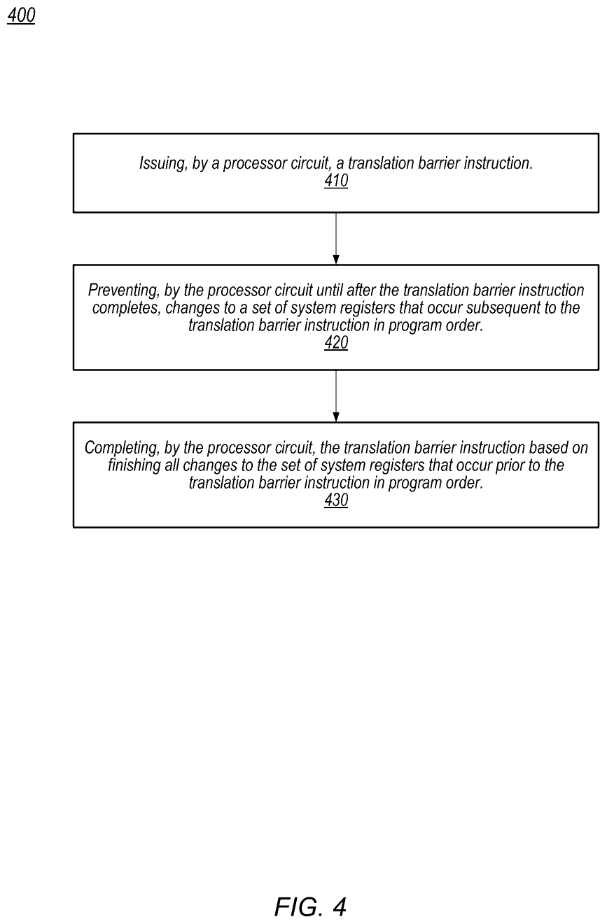

Moving now to FIG. 4, a flow diagram for an embodiment of a different method for performing, by a processor circuit, a translation barrier instruction is illustrated. In a similar manner to method 300, method 400 may be performed by a processor circuit, such as processor circuits 100 and 200 in FIGS. 1 and 2. Also similar to method 300, some or all of the operations of method 400 may be performed by execution circuits in the system that perform instructions stored in a non-transient memory such as microcode. Method 400 is described below using processor circuit 200 of FIG. 2 as an example. References to elements in FIG. 2 are included as non-limiting examples.

Method 400 begins in block 410 with processor circuit 200 issuing translation barrier instruction 142. Translation barrier instruction 142, for example, may be issued after one or more of TLBs 234, 274, and/or 284 have been populated with entries and registers 236, 276, and 286 having been set based on an address space associated with at least a portion of an active application. In preparation for a change to one or more of registers 236, 276, and 286, processor circuit 200 (e.g., decode circuit 240) may issue translation barrier instruction 242 prior to modifying any of registers 236, 276, and 286.

At block 420, method 400 continues with processor circuit 200 preventing, until after translation barrier instruction 142 completes, changes to a set of system registers that occur subsequent to translation barrier instruction 142 in program order. As previously disclosed, performance of translation barrier instruction 142 may block changes to particular ones of a set of system register, including, for example, one or more of registers 236, 276, and 286 based on store instructions that are younger than translation barrier instruction 142. Store instructions that are older than translation barrier instruction 142, however, may be allowed to proceed prior to completion of translation barrier instruction 142.

Method 400, at block 430, proceeds with processor circuit 200 completing translation barrier instruction 142 based on finishing all changes to the set of system registers that occur prior to translation barrier instruction 142 in program order. Conditions for translation barrier instruction 142 may be satisfied after all outstanding writes to associated system registers (e.g., one or more of registers 236, 276, and 286) related to instructions that are older than translation barrier instruction 142 have completed. Based on satisfying the conditions for translation barrier instruction 142, processor circuit 100 may proceed to perform subsequent instructions that are younger than translation barrier instruction 142.

It is noted that the method of FIG. 4 includes blocks 410-430. Method 400 may end in block 430, or may repeat some or all operations. For example, method 400 may repeat in response to receiving another instance of the translation barrier instruction. Method 400, similar to method 300, may be performed concurrently with a different instance of method 400. Methods 300 and 400 may be performed in combination based on the issue of translation barrier instruction 142.

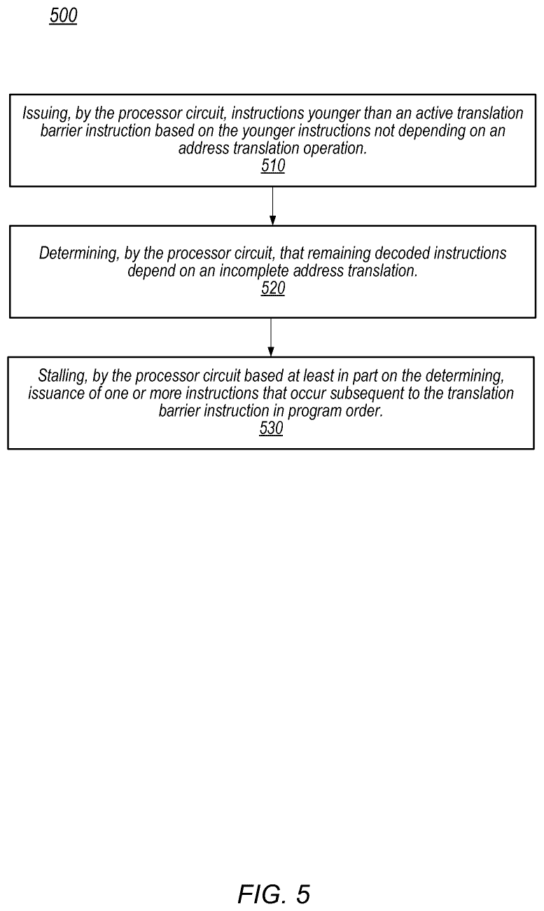

Turning now to FIG. 5, a flow diagram for an embodiment of a method for stalling, by a processor circuit, issue of instruction based on an active translation barrier instruction 142 is illustrated. In a similar manner to methods 300 and 400, method 500 may be performed by a processor circuit, such as processor circuits 100 and 200 in FIGS. 1 and 2. Method 500 is described below using processor circuit 100 of FIG. 1 as an example. References to elements in FIG. 1 are included as non-limiting examples. Method 500 may be performed concurrently with one or more operations of method 300, such as after block 310 and concurrent with blocks 320-330.

At block 510, method 500 begins with processor circuit issuing instructions younger than an active translation barrier instruction based on the younger instructions not depending on an address translation operation. For example, instructions 145c may be performed by processor circuit 100 while translation barrier instruction 142 is active based on a determination that instruction 145c is not dependent on a pending address translation. Many instructions may perform logic or arithmetic operations using operands that have previously been stored in one or more registers in a register file of processor circuit 100. Accordingly, any pending changes to an address table or to registers associated with address translations may not affect values that are currently stored in the register file.

Method 500 continues at block 520 with by processor circuit determining that remaining decoded instructions depend on an incomplete address translation. As instructions are permitted to proceed, younger instructions may be fetched and/or decoded. At some point in time, all decoded instructions may depend on a pending address translation that has been blocked from proceeding based on the active translation barrier instruction 142.

At block 530, method 500 continues by processor circuit 100, stalling, based at least in part on the determining, issuance of one or more instructions that occur subsequent to the translation barrier instruction in program order. For example, the pending instructions may be prevented from being issued due to the pending address translations. Once a supply of ready to issue instructions has been issued, instruction execution may be stalled until translation barrier instruction 142 completes.

It is noted that the method of FIG. 5 includes blocks 510-530. Method 500 may end in block 530, or may repeat some or all operations. For example, method 500 may repeat in response to receiving another instance of the instruction. Method 500, similar to methods 300 and 400, may be performed concurrently with a different instance of methods 300, 400, and/or 500.

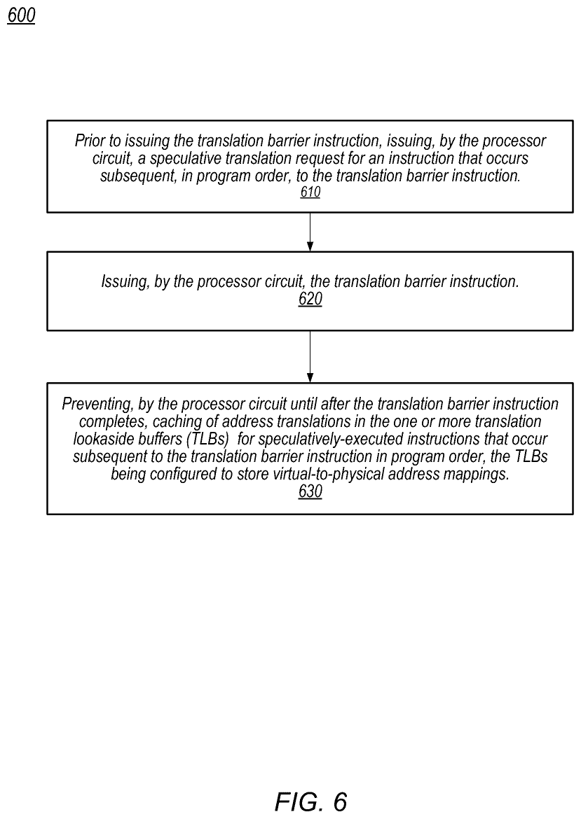

Proceeding now to FIG. 6, a flow diagram for an embodiment of a method for handling, by a processor circuit, a speculative translation request in combination with a translation barrier instruction is illustrated. In a similar manner to methods 300-500, method 600 may be performed by a system, such as processor circuits 100 and 200 in FIGS. 1 and 2. Method 600 is described below using processor circuit 100 of FIG. 1 as an example. References to elements in FIG. 1 are included as non-limiting examples. Method 600 may be performed concurrently with one or more operations of method 300, such as after block 310 and concurrent with blocks 320-330.

At block 610, method 600 begins with processor circuit 100, prior to issuing translation barrier instruction 142, issuing a speculative translation request for an instruction (e.g., instruction 145d) that occurs subsequent, in program order, to translation barrier instruction 142. As previously disclosed, processor circuit 100 may support out-of-order processing. Accordingly, processor circuit 100 may, prior to issuing translation barrier instruction 142, may issue an address translation request for instruction 145d prior to older ones of instructions 145 being issued. The speculative translation request may be sent to a translation table (e.g., included in or coupled to address circuitry 110) due to a virtual address associated with instruction 145d not having a corresponding entry in a TLB in address circuitry 110. Requesting a speculative translation may help to avoid delaying issue of instruction 145d due to waiting for an address translation at a later point in time.

Method 600 continues at block 620 with processor circuit 100 issuing the translation barrier instruction. After the speculative address translation has been requested, but prior to receiving a result of the translation, processor circuit 100 may issue translation barrier instruction 142, thereby preventing address translations for younger instructions from being requested. The speculative translation request for instruction 145d, however, is already in-flight and the virtual address may be allowed to be translated into a physical address based on current values in the translation table.

At block 630, method 600 proceeds with processor circuit 100, after issuing translation barrier instruction 142, preventing a result of the speculative translation request from being cached in the TLB. For example, although processor circuit 100 has issued the speculative translation request for instruction 145d to address circuitry 110, a result of the speculative translation may be received after translation barrier instruction 142 is issued. Based at least on issuing translation barrier instruction 142, processor circuit 100 prevents the result of the speculative translation from being cached in the TLB. Since processor circuit 100 may perform one or more instructions that modify the translation table, it is possible that the result of the speculative translation will be invalid at the point when instruction 145d is to be performed in program order. By blocking the result of the speculative translation from being cached, an invalid translation may be avoided.

It is noted that the method of FIG. 6 includes blocks 610-630. Method 600 may end in block 630, or may repeat some or all operations. For example, method 600 may repeat in response to issuing more than one speculative translation request before issuing translation barrier instruction 142. Method 600, similar to method 500, may be performed concurrently with a different instance of any of the disclosed methods.

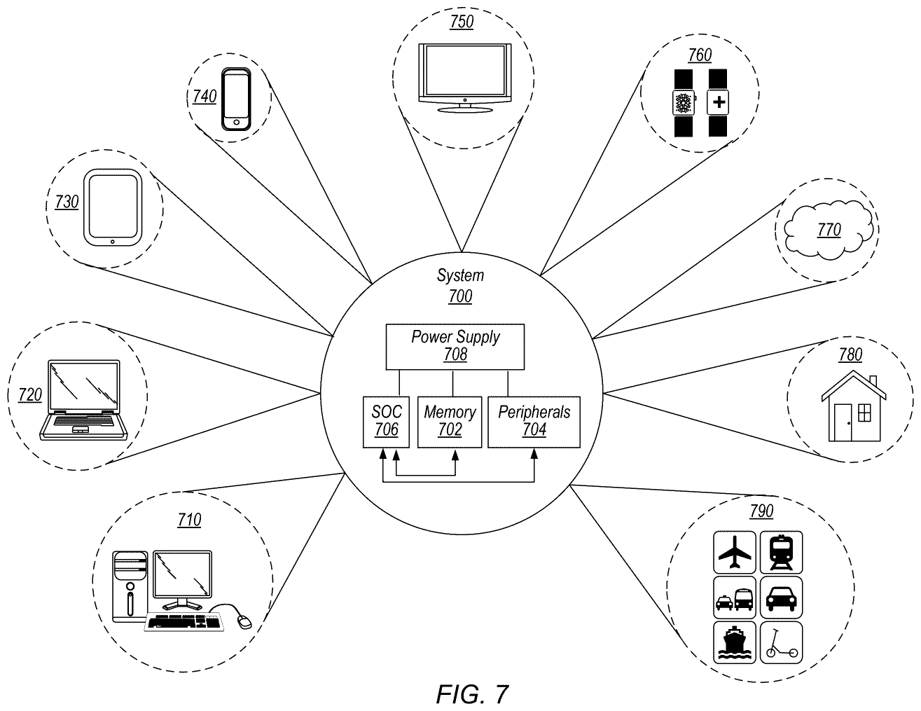

FIGS. 1-6 illustrate circuits and methods for a system, such as an SOC, that includes an execution pipeline capable of executing a translation barrier instruction. Any embodiment of the disclosed systems may be included in one or more of a variety of computer systems, such as a desktop computer, laptop computer, smartphone, tablet, wearable device, and the like. In some embodiments, the circuits described above may be implemented on a system-on-chip (SOC) or other type of integrated circuit, including multi-die packages. A block diagram illustrating an embodiment of system 700 is illustrated in FIG. 7. System 700 may, in some embodiments, include any disclosed embodiment of systems disclosed herein, such as processor circuits 100 and 200 shown in FIGS. 1 and 2.

In the illustrated embodiment, the system 700 includes at least one instance of a system on chip (SOC) 706 which may include multiple types of processor circuits, such as a central processing unit (CPU), a graphics processing unit (GPU), or otherwise, a communication fabric, and interfaces to memories and input/output devices. SOC 706 may correspond to an instance of the processor circuits and/or systems disclosed herein. In various embodiments, SOC 706 is coupled to external memory circuit 702, peripherals 704, and power supply 708.

A power supply 708 is also provided which supplies the supply voltages to SOC 706 as well as one or more supply voltages to external memory circuit 702 and/or the peripherals 704. In various embodiments, power supply 708 represents a battery (e.g., a rechargeable battery in a smart phone, laptop or tablet computer, or other device). In some embodiments, more than one instance of SOC 706 is included (and more than one external memory circuit 702 is included as well.

External memory circuit 702 is any type of memory, such as dynamic random-access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS DRAM (RDRAM), static RAM (SRAM), etc. In some embodiments, external memory circuit 702 may include non-volatile memory such as flash memory, ferroelectric random-access memory (FRAM), or magnetoresistive RAM (MRAM). One or more memory devices may be coupled onto a circuit board to form memory modules such as single inline memory modules (SIMMs), dual inline memory modules (DIMMs), etc. Alternatively, the devices may be mounted with a SOC or an integrated circuit in a chip-on-chip configuration, a package-on-package configuration, or a multi-chip module configuration.

The peripherals 704 include any desired circuitry, depending on the type of system 700. For example, in one embodiment, peripherals 704 includes devices for various types of wireless communication, such as Wi-Fi, Bluetooth, cellular, global positioning system, etc. In some embodiments, the peripherals 704 also include additional storage, including RAM storage, solid state storage, or disk storage. The peripherals 704 include user interface devices such as a display screen, including touch display screens or multitouch display screens, keyboard or other input devices, microphones, speakers, etc.

As illustrated, system 700 is shown to have application in a wide range of areas. For example, system 700 may be utilized as part of the chips, circuitry, components, etc., of a desktop computer 710, laptop computer 720, tablet computer 730, cellular or mobile phone 740, or television 750 (or set-top box coupled to a television). Also illustrated is a smartwatch and health monitoring device 760. In some embodiments, the smartwatch may include a variety of general-purpose computing related functions. For example, the smartwatch may provide access to email, cellphone service, a user calendar, and so on. In various embodiments, a health monitoring device may be a dedicated medical device or otherwise include dedicated health related functionality. In various embodiments, the above-mentioned smartwatch may or may not include some or any health monitoring related functions. Other wearable devices 760 are contemplated as well, such as devices worn around the neck, devices attached to hats or other headgear, devices that are implantable in the human body, eyeglasses designed to provide an augmented and/or virtual reality experience, and so on.

System 700 may further be used as part of a cloud-based service(s) 770. For example, the previously mentioned devices, and/or other devices, may access computing resources in the cloud (i.e., remotely located hardware and/or software resources). Still further, system 700 may be utilized in one or more devices of a home 780 other than those previously mentioned. For example, appliances within the home may monitor and detect conditions that warrant attention. Various devices within the home (e.g., a refrigerator, a cooling system, etc.) may monitor the status of the device and provide an alert to the homeowner (or, for example, a repair facility) should a particular event be detected. Alternatively, a thermostat may monitor the temperature in the home and may automate adjustments to a heating/cooling system based on a history of responses to various conditions by the homeowner. Also illustrated in FIG. 7 is the application of system 700 to various modes of transportation 790. For example, system 700 may be used in the control and/or entertainment systems of aircraft, trains, buses, cars for hire, private automobiles, waterborne vessels from private boats to cruise liners, scooters (for rent or owned), and so on. In various cases, system 700 may be used to provide automated guidance (e.g., self-driving vehicles), general systems control, and otherwise.

It is noted that the wide variety of potential applications for system 700 may include a variety of performance, cost, and power consumption requirements. Accordingly, a scalable solution enabling use of one or more integrated circuits to provide a suitable combination of performance, cost, and power consumption may be beneficial. These and many other embodiments are possible and are contemplated. It is noted that the devices and applications illustrated in FIG. 7 are illustrative only and are not intended to be limiting. Other devices are possible and are contemplated.

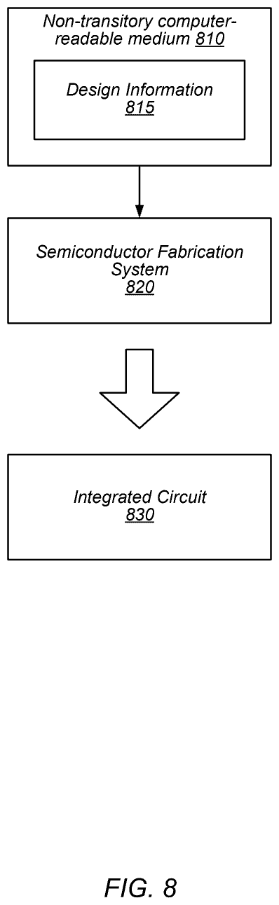

As disclosed in regard to FIG. 7, system 700 may include one or more integrated circuits included within a personal computer, smart phone, tablet computer, or other type of computing device. A process for designing and producing an integrated circuit using design information is presented below in FIG. 8.

FIG. 8 is a block diagram illustrating an example of a non-transitory computer-readable storage medium that stores circuit design information, according to some embodiments. The embodiment of FIG. 8 may be utilized in a process to design and manufacture integrated circuits, for example, including one or more instances (or portions thereof) of processor circuits 100 and 200 that are disclosed above. In the illustrated embodiment, semiconductor fabrication system 820 is configured to process the design information 815 stored on non-transitory computer-readable storage medium 810 and fabricate integrated circuit 830 based on the design information 815.

Non-transitory computer-readable storage medium 810, may comprise any of various appropriate types of memory devices or storage devices. Non-transitory computer-readable storage medium 810 may be an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 810 may include other types of non-transitory memory as well or combinations thereof. Non-transitory computer-readable storage medium 810 may include two or more memory mediums which may reside in different locations, e.g., in different computer systems that are connected over a network.

Design information 815 may be specified using any of various appropriate computer languages, including hardware description languages such as, without limitation: VHDL, Verilog, SystemC, SystemVerilog, RHDL, M, MyHDL, etc. Design information 815 may be usable by semiconductor fabrication system 820 to fabricate at least a portion of integrated circuit 830. The format of design information 815 may be recognized by at least one semiconductor fabrication system, such as semiconductor fabrication system 820, for example. In some embodiments, design information 815 may include a netlist that specifies elements of a cell library, as well as their connectivity. One or more cell libraries used during logic synthesis of circuits included in integrated circuit 830 may also be included in design information 815. Such cell libraries may include information indicative of device or transistor level netlists, mask design data, characterization data, and the like, of cells included in the cell library.

Integrated circuit 830 may, in various embodiments, include one or more custom macrocells, such as memories, analog or mixed-signal circuits, and the like. In such cases, design information 815 may include information related to included macrocells. Such information may include, without limitation, schematics capture database, mask design data, behavioral models, and device or transistor level netlists. As used herein, mask design data may be formatted according to graphic data system (gdsii), or any other suitable format.

Semiconductor fabrication system 820 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 820 may also be configured to perform various testing of fabricated circuits for correct operation.

In various embodiments, integrated circuit 830 is configured to operate according to a circuit design specified by design information 815, which may include performing any of the functionality described herein. For example, integrated circuit 830 may include any of various elements shown or described herein. Further, integrated circuit 830 may be configured to perform various functions described herein in conjunction with other components.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors.

Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]-is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
a processor circuit configured to execute a translation barrier instruction, wherein to execute the translation barrier instruction, the processor circuit is configured to:
prevent, until after the translation barrier instruction completes, address translations for instructions that occur subsequent to the translation barrier instruction in program order; and
complete the translation barrier instruction based on finishing all address translations for instructions that occur prior to the translation barrier instruction in program order.

2. The apparatus of claim 1, further comprising:
a set of system registers;
wherein to execute the translation barrier instruction, the processor circuit is configured to:
prevent, until after the translation barrier instruction completes, changes to the set of system registers that occur subsequent to the translation barrier instruction in program order; and
complete the translation barrier instruction based on finishing all changes to the set of system registers that occur prior to the translation barrier instruction in program order.

3. The apparatus of claim 2, wherein the set of system registers is all system registers.

4. The apparatus of claim 2, wherein the set of system registers are all registers that affect address translation.

5. The apparatus of claim 2, wherein the set of system registers are all registers that affect address permissions.

6. The apparatus of claim 2, wherein the set of system registers are all registers that affect address translation or address permissions.

7. The apparatus of claim 6, wherein the set of system registers includes a base address register that stores a base address of a page table or a permission table.

8. The apparatus of claim 1, further comprising:
one or more translation lookaside buffers (TLBs) configured to store virtual-to-physical address mappings;
wherein to execute the translation barrier instruction, the processor circuit is configured to:
prevent, until after the translation barrier instruction completes, caching of address translations in the one or more TLBs for speculatively-executed instructions that occur subsequent to the translation barrier instruction in program order.

9. The apparatus of claim 1, wherein to prevent the address translations for instructions that occur subsequent to the translation barrier instruction, the processor circuit is configured to stall issuance of one or more instructions that occur subsequent to the translation barrier instruction in program order.

10. A method comprising:
in response to issuing, by a processor circuit, a translation barrier instruction:
preventing, by the processor circuit until after the translation barrier instruction completes, pending address translations for instructions that occur subsequent to the translation barrier instruction in program order; and
completing, by the processor circuit, the translation barrier instruction based on finishing all address translations for instructions that occur prior to the translation barrier instruction in program order.

11. The method of claim 10, further comprising, in response to issuing the translation barrier instruction:
preventing, by the processor circuit until after the translation barrier instruction completes, changes to a set of system registers that occur subsequent to the translation barrier instruction in program order; and
completing, by the processor circuit, the translation barrier instruction also based on finishing all changes to the set of system registers that occur prior to the translation barrier instruction in program order.

12. The method of claim 11, wherein the set of system registers is all system registers.

13. The method of claim 11, wherein the set of system registers are all registers that affect address translation.

14. The method of claim 11, wherein the set of system registers are all registers that affect address translation or address permissions.

15. The method of claim 10, wherein the preventing includes stalling issuance of one or more instructions that occur subsequent to the translation barrier instruction in program order.

16. The method of claim 10, further comprising, in response to issuing the translation barrier instruction:
preventing, until after the translation barrier instruction completes, caching of address translations in one or more translation lookaside buffers (TLBs) for speculatively-executed instructions that occur subsequent to the translation barrier instruction in program order, the one or more TLBs being configured to store virtual-to-physical address mappings.

17. An apparatus, comprising:
a processor circuit that includes an instruction pipeline circuit that is configured to execute a translation barrier instruction, wherein to execute the translation barrier instruction, the instruction pipeline circuit is configured to:
perform address translations for instructions in the instruction pipeline circuit that are older than the translation barrier instruction;
prevent address translations for instructions in the instruction pipeline circuit that are younger than the translation barrier instruction; and
complete the translation barrier instruction based on finishing the address translations for all the instructions in the instruction pipeline circuit that are older than the translation barrier instruction.

18. The apparatus of claim 17, further comprising a set of system registers, and wherein the instruction pipeline circuit is further configured to:
prevent changes to the set of system registers made by instructions in the instruction pipeline circuit that are younger than the translation barrier instruction;
permit changes to the set of system registers made by instructions in the instruction pipeline circuit that are older than the translation barrier instruction; and
complete the translation barrier instruction based also on completion of the changes to the set of system registers made by the instructions in the instruction pipeline circuit that are older than the translation barrier instruction.

19. The apparatus of claim 18, wherein the set of system registers includes registers that affect address translation or address permissions.

20. The apparatus of claim 19, further comprising:
one or more translation lookaside buffers (TLBs) configured to store virtual-to-physical address mappings;
wherein to execute the translation barrier instruction, the instruction pipeline circuit is further configured to:
prevent, until after the translation barrier instruction completes, caching of address translations in the one or more TLBs for speculatively-executed instructions that are younger than the translation barrier instruction.
